(19) United States
(12) Patent Application Publication
(10) Pub. No.: US 2020/0005400 A1
(43) Pub. Date: Jan. 2, 2020

(54) SELECTION SYSTEM OF COMPARABLE COMPANIES

(71) Applicant: Yoshihisa Shiokawa, Tokyo (JP)

(72) Inventor: Yoshihisa Shiokawa, Tokyo (JP)

(21) Appl. No.: 16/454,081

(22) Filed: Jun. 27, 2019

(30) Foreign Application Priority Data
Jun. 28, 2018 (JP) 2018-122836

(51) Int. Cl. G06Q 40/00

(52) U.S. Cl. CPC G06Q 40/10; G06Q 40/123

(57) ABSTRACT

The present invention intends to provide a highly reliable and economical selection system of comparable companies, which can save time and effort required for the manual selection of comparable companies for responding to transfer pricing taxation. The selection system of comparable companies 1 of the present invention comprises of a storage means to store company information on a plurality of companies, an analysis means to calculate the degree of similarity between the tested company and the companies stored in the storage means based on the company information of the tested company and the company information of the companies stored in the storage means, and a selection means to further filter the plurality of candidate companies for comparison based on the degree of similarity calculated by the analysis means.

### TECHNICAL FIELD

The present invention is related to a selection system of comparable companies and is useful as a system, especially for analysis of transfer pricing taxation, that computes the qualitative degree of similarity with the company where the users work, and effectively filters and selects comparable companies with a high degree of similarity for comparison.

### BACKGROUND

In compliance with the final recommendations of BEPS (OECD/G20 Inclusive Framework on Base Erosion and Profit Shifting, which is an initiative to prevent excessive tax avoidance by multinational companies) announced by OECD in September 2015, countries around the world coordinately introduced transfer pricing taxation rules in recent years, and companies including companies from Japan are bound by various transfer pricing taxation rules including simultaneous documentation.

According to the various transfer pricing taxation rules, companies actively engaged in international transactions within a group are requited to prepare a large number of documents each year with a limited number of people and in a limited period, since transfer pricing is a highly specialized field, it is considered difficult to provide adequate support unless managed by specialists such as some of the international accounting firms, there are few entrants in this field and it is lagging in automation and streamlining of operations through effective usage of IT technology.

Specifically, all steps required for the above documentation work is performed almost manually by other competitors such as certified tax accountant offices and to complete one document, 3 to 4 persons will have to work for approximately 4 to 6 months. Also, if the total billing for the transaction with a party is in the order of several million yen, the corresponding tax handling expenses tend to be comparatively high. For this reason, there was a pressing need for the development of new documentation technology that combines expertise and work speed.

Generally, the transfer pricing documentation includes documents for substantiating the appropriateness of the transaction price for each transaction between the concerned parties, by comparing the transaction price with the price and profit rate in other similar transactions. The work steps involved in the preparation of transfer pricing documentation generally include (1) Information collection, (2) Interviews, (3) Functional rise analysis, (4) Review of transfer pricing calculation method or transfer pricing methodology, (5) Economic analysis and (6) Documentation of results of a series of transfer pricing analysis (In some cases, including translation works in multiple languages).

As the technology to prepare the above documents, a technology that provides the know-how to prepare the documentation for transfer pricing, as shown in Patent Document 1, is available (Patent Document 1).

Patent document 1: Patent utility model JP 3212309

According to the technology described in Patent Document 1, since it is possible to prepare the documentation by selecting an optimal method from among a plurality of transfer pricing calculation methods with the provision of the blow-how to prepare the transfer pricing documentation, it can be prepared without outsourcing.

### SUMMARY

However, although (4) and (6) among the above (1) to (6) can be supported with the technology of Patent Document 1, other points are not mentioned.

For (5) Economic analysis in the above items, it is normal to select (screen) companies whose business description and traded products etc. are similar to the tested company, and then to carry out economic analysis with these selected companies as the comparable companies. In the previous method that was used to select comparable companies, company information of each company (company information includes quantitative information and/or qualitative information) is manually analyzed to shortlist several or several tens of companies from numerous candidate companies, which requires time and effort, and there has been a long-standing demand for the establishment of an automation technology to select the companies.

The present invention has been made in consideration of such a demand, and the object is to provide this selection system of comparable companies that enables to prepare for economic analysis necessary for transfer pricing documentation with less personnel in a shorter period and at a lower cost than at present, by developing original analysis methods, tools for automated comparability analysis and an IT system providing the above analysis methods and tools, and by improving the work efficiency.

The present invention provides the following solution.

The invention according to the first aspect is a selection system of comparable companies, which provides the selection system of comparable companies comprising of a storage means for storing the company information on a plurality of companies, an analysis means to calculate the degree of similarity between the tested company and the companies stored in the storage means based on the company information of the tested company and the company information of the companies stored in the storage means, and a selection means to further filter the plurality of candidate companies for comparison based on the degree of similarity calculated by the analysis means.

According to the invention of the first aspect, it is possible to provide a selection system of comparable companies, which can automatically filter companies having a high degree of similarity and relevance from among a plurality of companies, without using manual operations.

The invention according to the second aspect is the invention according to the first aspect, which provides a selection system of comparable companies, wherein the company information is formed from a plurality of items, the degree of similarity is formed from the respective degree of similarity for each item of the plurality of items, and the overall degree of similarity is formed by the comprehensive evaluation of the degree of similarity for each item, and the analysis means calculates the degree of similarity for each item and the overall deuce of similarity, and the selection means filters the plurality of companies based on the overall degree of similarity.

According to the invention of the second aspect, the company information is formed from a plurality of items, and since the degree of similarity is formed from the degree of similarity of each item of the plurality of items and/or the overall degree of similarity from the comprehensive evaluation of the degree of similarity for each item, it is possible to provide a highly reliable system capable of performing multi-faceted analysis on a plurality of items.

The invention according to a third aspect is the invention according to the second aspect, which provides a selection system of comparable companies in which the overall degree of similarity is calculated as a cosine value of a single or multi-dimensional vector.

According to the invention of the third aspect, since the overall degree of similarity is calculated as a cosine value of a single-or multi-dimensional vector, the degree of similarity can be evaluated at a plurality of steps, and it can provide a system that is capable of easily comparing the degree of similarity.

According to the present invention, it is possible to reduce the time and effort required to manually select candidate companies for comparison and provide a highly reliable and economical selection system of comparable companies.

### BRIEF DESCRIPTION OF DRAWINGS

FIG. 1 is a block diagram showing the hardware configuration and software functions of the selection system of comparable companies of the present embodiment.

FIG. 2 is a flow chart showing the preliminary preparations for selecting companies.

FIG. 3 is a diagram showing an example of a screen to input information of companies.

FIG. 4 is a diagram showing the example of company database 310.

FIG. 5 is a flow chart showing the procedure for selecting companies.

FIG. 6 is a diagram showing an example of the screen to input a tested company name for verification.

### DETAILED DESCRIPTION

The embodiments for implementing the present disclosure are described with reference to the diagram. This is just an example, and the technical scope of the present invention is not limited to this example.

Configuration of Selection System for Comparable Companies 1:

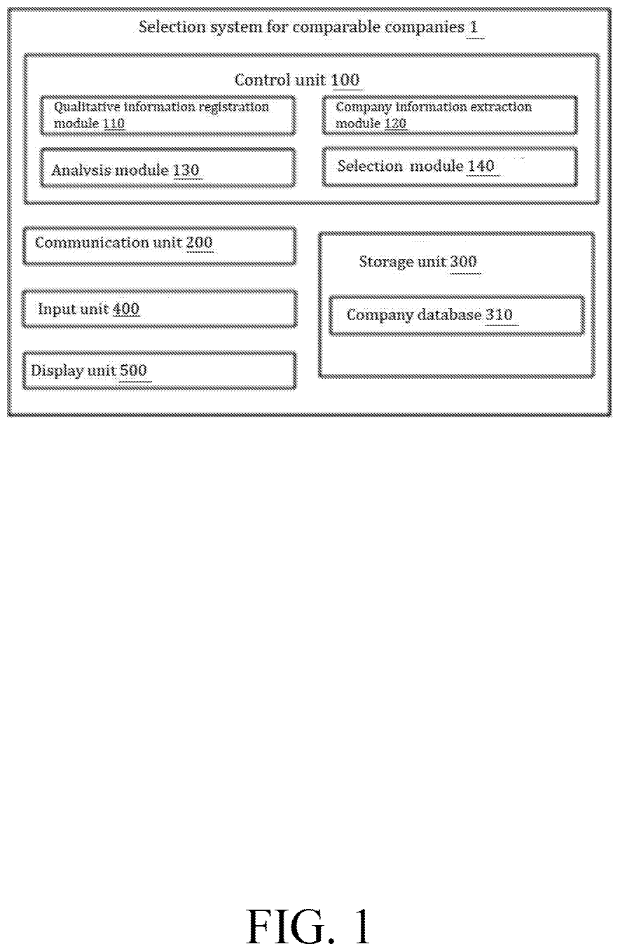

FIG. 1 is a block diagram to explain the hardware configuration and software functions of a selection system for comparable companies 1 of the present embodiment.

The selection system for comparable companies 1 comprises of a control unit 100 that controls data, a communication unit 200 that communicates with users and other devices, a storage unit 300 that stores data, an input unit 400 that receives input of information from the user, and a display unit 500 that outputs data and images controlled by the control unit 100.

The control unit 100 includes a central processing unit (CPU), a random-access memory (RAM), and a read-only memory (ROM) and those equivalents etc.

The communication unit 200 includes a device for enabling communication with other devices, for example, IEEE 802.11 compliant device compatible with Wi-Fi (Wireless FIDelity).

The control unit 100 implements a company information registration module 110, an analysis module 120, and a selection module 130 by reading the specified program and in cooperation with the communication unit 200 and/or the storage unit 300 as necessary.

The storage unit 300 is a device that includes a data storage unit such as a hard disk, a semiconductor memory, a recording media, or a memory card etc., and stores data and files. The storage unit 300 stores the company database 310 that will be described later.

There is no particular limitation on the input unit 400. Examples for the input unit 400 include a keyboard, a mouse, and a touch panel.

There is no particular limitation on the display unit 500. Examples of the display unit 500 include a monitor and a touch panel.

Preliminary Preparations Using the Selection System of Comparable Companies 1:

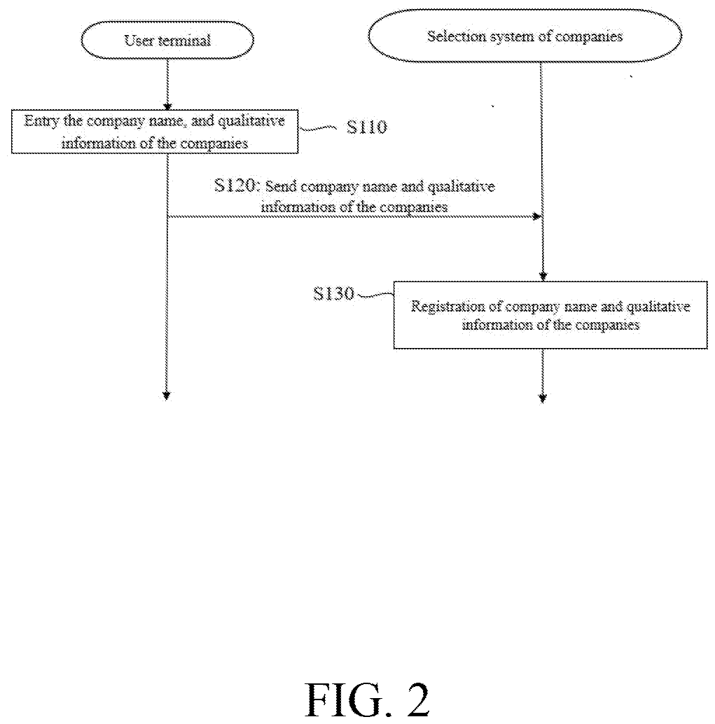

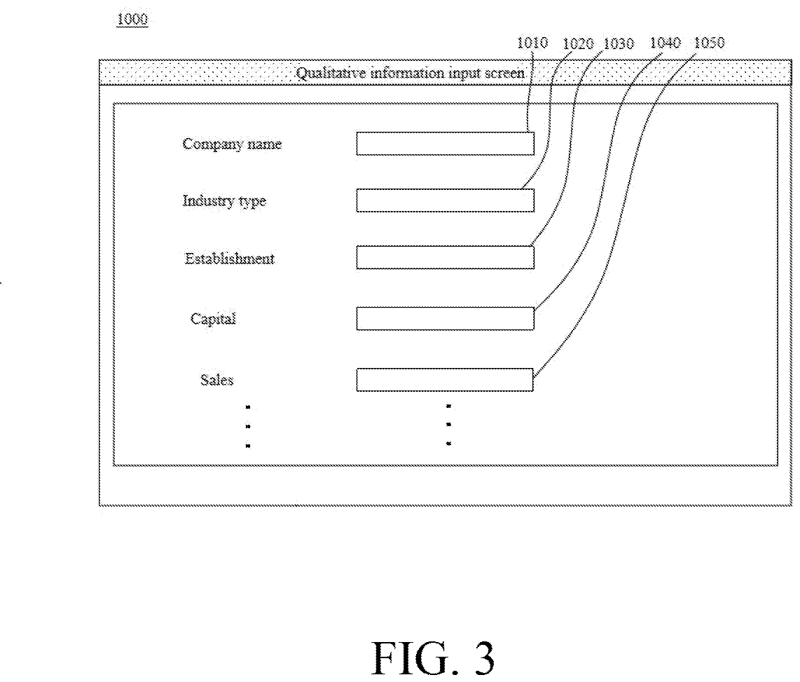

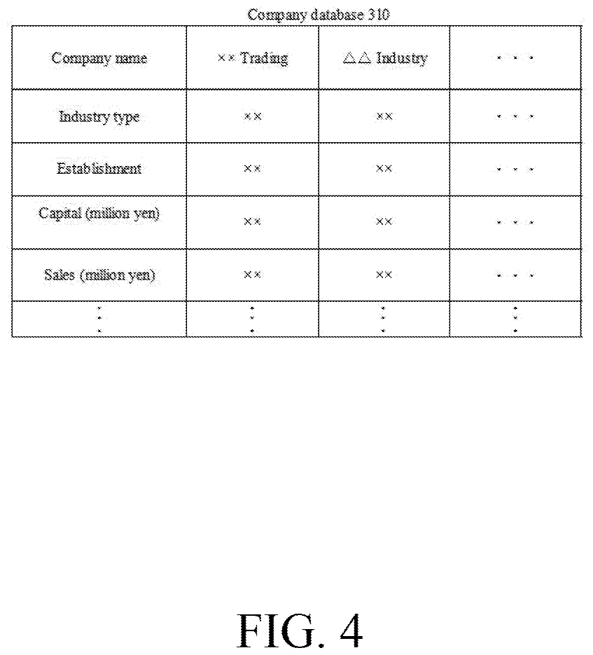

The preliminary preparations performed before the implementation of company selection using the selection system of comparable companies 1 in the present embodiment will be described. FIG. 2 is a flowchart of the preliminary preparations using the selection system of comparable companies. FIG. 3 is a diagram showing an example of an input screen 1000 to input the information of a company, FIG. 4 is a diagram showing an example of the company database 310. Each of the hardware modules described above and the process performed by the software modules will be described with reference to FIGS. 1 to 4.

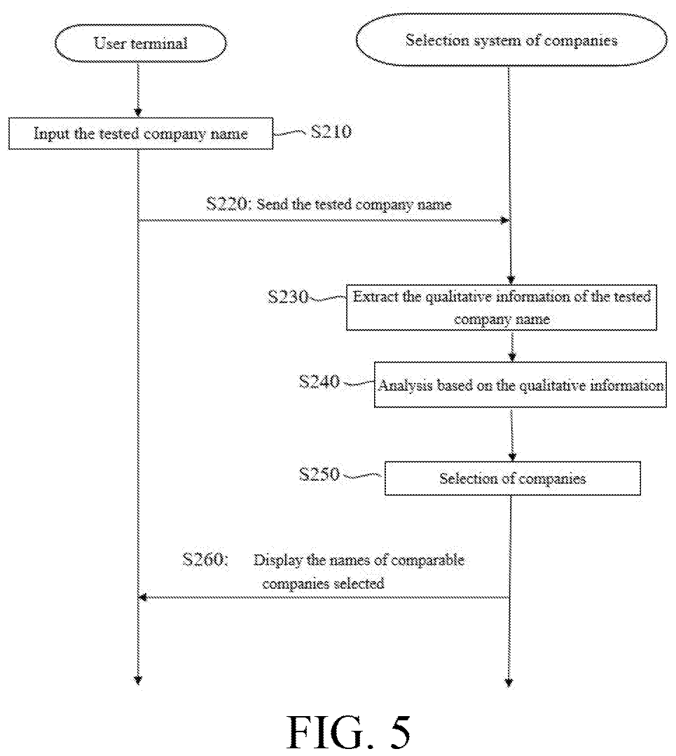

FIG. 4 is a flowchart of a display panel driving process according to one embodiment of the present disclosure. FIG. 5 is a flowchart of a backlight module driving process according to one embodiment of the present disclosure. As shown in FIGS. 4 and 5, the present disclosure provides a driving method of a display module, includes a display panel driving process, and a backlight module driving process driven synchronously with the display panel driving process. The display module includes a plurality of first color light sources and second color light sources. The first color light sources and the second color light sources are controlled independently.

Steps S110 to S130: Entry of Company Information on Companies:

First, as preliminary preparations for implementing the selection system of comparable companies, the company name and company information of the tested and/or candidate companies are input, and the company database 310 is created. A user, who intends to select a company using the selection system of comparable companies 1 inputs the company name 1010 and the company information in a predetermined format as illustrated in FIG. 3 from the unit being used (user terminal) (step S110) and sends the company name, company information and any additional specific selection criteria as required by accessing the selection system of comparable companies 1 through the Internet (step S120).

For corporate information input in step S110, as illustrated in FIG. 3, for example, industry type 1020 such as finance steel, manufacturing and telecommunication, business outline 1030 showing the description of the main business, establishment 1040 representing the year and month of establishment of the company, capital 1050 and sales 1060 can be input. Although it is not illustrated, items to be used as references such as the amount of profits and the number of employees are also input when calculating the degree of similarity between companies by comparison. The company information on the plurality of items is input in association with the company name used for identifying the company stored in the database. As illustrated in FIG. 3, a plurality of pre-defined items can be input in the predetermined format, and the user inputs the plurality of items in the appropriate format.

Although the company information has been directly input from the user terminal in step S110, it may also be obtained from existing company information databases. That is, the specific company information of many companies for screening, such as industry classification code, country and region name etc. may also be obtained in one step from existing company information databases provided by private enterprises. By using this method, the time and effort required to input a large amount of data can be saved.

In step S120, though the company information is sent from the user terminal to the selection system of comparable companies 1 through the Internet, the selection system of comparable companies 1 may also be integrated with the user terminal.

When the company name and company information are received from the user terminal, the control unit 100 of the selection system of comparable companies 1 executes the company information registration module 110 in cooperation with the storage unit 300, and the corresponding company name and company information input by the operation of the user is registered in the company database 310 of the storage unit 300, as illustrated in FIG. 4 (step S130).

In the company database 310, an example of which is illustrated in FIG. 4, the company name and corresponding company information linked to the company name registered in step S130 are stored for each item.

The company database 310 is then created by repeatedly executing steps S110 to S130 for different companies, and this completes the preliminary preparation.

The company information of an adequate number of companies should be listed to perform the selection of companies in the company database 310. For example, 200 companies may be required to be registered in the company database 310.

When preparing the company database 310, it is possible to create the database by inputting the company information on a plurality of companies at one time, or by adding the company information as needed and updating the information listed in the company database 310.

Selection of Companies Using the Selection System of Comparable Companies 1:

Next, according to the flowchart shown in FIG. 5, a method for selecting a company is described where the companies registered in the company database 310 are filtered to a targeted number of companies, for comparison, which are similar to the tested company that is to be verified, using the selection system of comparable companies 1 in the present embodiment.

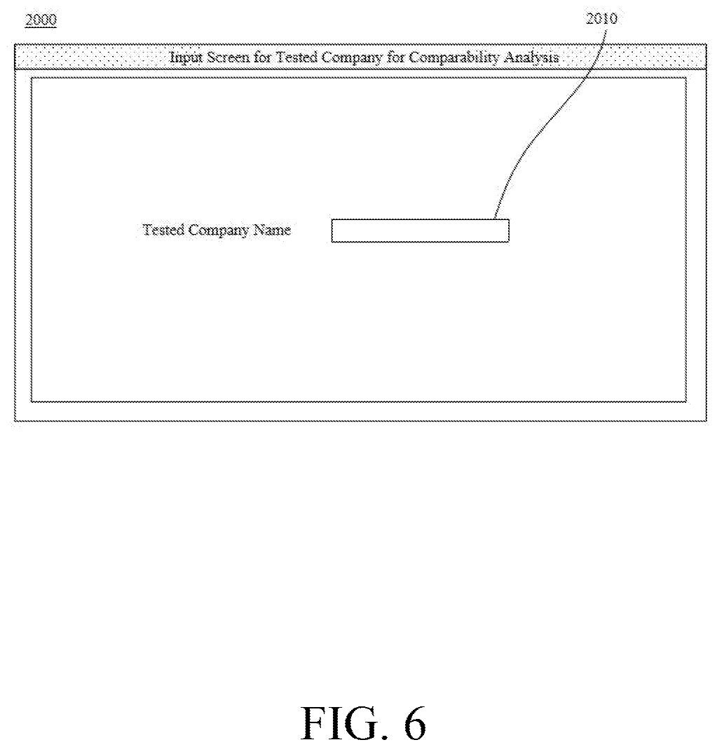

First, a user who wants to select a company using the selection system of comparable companies 1, inputs the tested company name 2010 and the company information in a predetermined format from the user terminal as illustrated in FIG. 6 (step S210), then the selection system of comparable companies 1 is accessed through the Internet, and the tested company name is sent to the selection system (step S220).

The name of the tested company, which is input in step S210, is the company to be verified that is used to select similar companies in the next step, and in most cases, it indicates the company itself or group company of the users. Therefore, the company information of only the tested company is input in step S210. In the case that the company information of the tested company has already been stored in the company database 310, the information of the company can be called and used.

The company information items of the tested company input in step S210 are the same items registered in the company database 310, including industry type 2020, business outline 2030, establishment 2040, capital 2050 and sales 2060 etc.

When the name and the company information of the tested company are received from the user terminal in step S220, the company unit 100 of the selection system of comparable companies 1 executes the analysis module 120 in cooperation with the storage unit 300, and analysis based on the comparison of company information is carried out (step S230).

In step S230, the same items in the company information are compared, and the degree of similarity of each item is scored. For example, when scoring the degree of similarity for the item “Industry type”, the difference between the industry type of the company to be verified and the industry type of the company that is to be compared is scored with the qualitative or language data that has been machine-learned in advance and a predetermined algorithm. Also, the algorithm used for scoring is defined in advance for each item.

By scoring the degree of similarity of each item for all or some of the registered items, the overall degree of similarity, which is a quantification of the overall degree of similarity between the companies, is calculated. The overall degree of similarity is obtained by comprehensively evaluating the degree of similarity of each item and is calculated based on all or part of the degree of similarity of each item, for example, as an arithmetic mean of all the degree of similarity of each item.

In the present embodiment, the overall degree of similarity of company information is calculated, for example, as a cosine (COS) value of a 15-dimensional vector. In other words, with the origin of the XY coordinates as reference, the overall degree of similarity is calculated as a vector in which the directions from the most similar 1 to the least similar −1 are compressed in 15 dimensions, and a numerical value between 1 and −1 is calculated with the cosine of these vectors. This enables evaluation of the degree of similarity between companies with numerical values of 15 levels based on the company information, and to compare the degree of similarity easily.

In the present embodiment, though the configuration is such that the overall degree of similarity is calculated as a cosine value of a 15-dimensional vector, the number need not be limited to 15 dimensions, any number can be set from one dimension to a plurality of dimensions. This enables the number of dimensions to be changed m accordance with the number of companies to be compared and verified, and the amount of company information.

The calculation of the overall degree of similarity is carried out for all the companies registered in the company database 310 or companies meeting the selection criteria, and the overall degree of similarity with the tested company is calculated for all those companies.

When the overall degree of similarity is calculated for all the companies that were registered in step S230 the control unit 100 executes the selection module 130 to list all the companies in the descending order of the calculated overall degree of similarity, or filters further to a targeted number of companies, for example, the top 10 or 15 companies (step S240).

When all or a targeted number of companies are selected in step S240, the selected company names etc. are sent to the user terminal, and the process is completed (step S250).

By configuring as described above, the work of filtering companies with high relevance out of a large number of companies can be performed automatically without depending on manual operation, and a highly reliable and economical selection system of comparable companies can be provided.

Though embodiments of the present invention have been described, the present invention is not limited to the embodiments mentioned above. The effects described in the embodiments of the present invention only list the most preferred effects that are from the present invention, and the effects according to the present invention are not limited to the effects described in the embodiments of the present invention.

1 Selection System of Comparable Companies:

100 . . . Control unit

110 . . . Company information registration module

120 . . . Analysis module

130 . . . Selection module

200 . . . Communication unit

300 . . . Storage unit

310 . . . Company database

What is claimed is:

1. A selection system of comparable companies that selects companies to carry out the economic analysis required for the transfer pricing documentation, which includes documents to substantiate the appropriateness of the transaction price or the profit level for transactions between related parties by comparing the transaction price or the profit rate for other similar transactions with or between third parties, comprising of:
a storage means for storing company information on a plurality of companies; and
an analysis means to calculate the degree of similarity between the tested company and the companies stored in the storage means, based on the company information that includes qualitative information of the tested company and the company information that includes qualitative information of the companies stored in the storage means; and
a selection means to further filter the plurality of candidate companies for comparison based on the degree of similarity calculated by the analysis means;
wherein the company information is formed from a plurality of items; and
the degree of similarity is formed from the respective degree of similarity for each item of the plurality of items, and the overall degree of similarity is formed by the comprehensive evaluation of the degree of similarity for each item;
an analysis means,
calculates the degree of similarity for each of the plurality of items of the qualitative information included in the company information by scoring each of the same items in the qualitative information included in the company information in accordance with the qualitative or language data that was machine learned in advance and algorithm predetermined for each item; and
calculates the overall degree of similarity between companies which is the quantification of the comprehensive degree of similarity based on all or part of the degree of similarity calculated for each item; and
a selection means, selects comparable companies from the plurality of companies based on the overall degree of similarity.

2. The selection system of comparable companies according to claim 1, wherein the overall degree of similarity is calculated as a cosine value of a single or multi-dimensional vector.
